(19) United States
(12) Patent Application Publication
(10) Pub. No.: US 2013/0024840 A1
(43) Pub. Date: Jan. 24, 2013

(54) Handwriting images onto an internet supported webpage in real time

(71) Applicants: Chiaka Chukwuma Okoroh, Chicago, IL (US); Nathaniel A. Moore, Chicago, IL (US)

(72) Inventors: Chiaka Chukwuma Okoroh, Chicago, IL (US); Nathaniel A. Moore, Chicago, IL (US)

(21) Appl. No.: 13/199,061

(22) Filed: Aug. 19, 2011

Related U.S. Application Data
(60) Provisional application No. 61/510,859, filed on Jul. 22, 2011.

(51) Int. Cl. G06F 9/44

(52) U.S. Cl. 717/120

(57) ABSTRACT

The ability to handwrite documents onto a website in real time inherently is intended to by synonymous with the ability to handwrite any image onto an Internet supported webpage in real time. The software that will support this online handwriting technology is called the Web Based Writing System (WBWS). The hardware required to support this technology is an Internet capable device which may be accessorized with a digital writing pad and stylus, a mouse or even existing handwriting software (software understood to not currently be web compatible). A description of the WBWS is listed in the claims section of this application.

### CROSS REFERENCE TO RELATED APPLICATIONS

This patent is related to Provisional Patent (EFS ID 10581690, Application No. 61/510,859).

### BACKGROUND OF THE INVENTION

Synchronous distance learning occurs when the teacher and his/her pupils interact in different places at the same time. Students enrolled in synchronous courses are generally required to log on to their computer during a set time at least once a week. Synchronous distance learning may include multimedia components such as group chats, web seminars, video conferencing, and phone call-ins. Generally, synchronous learning works best for students who can schedule set days and times for their studies. It is often preferred by those who like structured courses heavy on student interaction. As we all know, the online environment is text-based. Communication with an instructor and other students in an online classroom requires the participants to type messages and post responses. For many students, typing is slower than writing. The point is that you will likely learn more in an online classroom environment, but you will have to make a greater effort to accomplish that learning.

Online tutoring services cover a wide spectrum of capabilities. Some are legitimate, with tutors who are interested in helping a student learn the material on their own. Other sites provide answers to homework problems with no explanations given. It is sites like these that have teachers worried about the value of the help they offer. There are quick-fix sites with little quality control or real concern about a student's education. Independent research shows a tremendous increase in supplemental academic learning services. With standards falling in many schools and competition fierce for college entry, more parents and students are turning to private tutors for assistance. There is a growing need for parents to access the best private tutors for a particular subject, no matter the location.

### SUMMARY OF THE INVENTION

Online tutoring services that use digital ‘whiteboards’ to show work and explain how to solve problems are likely to be a much better long-term solution than email help services. There exists a potential opportunity for online educators and tutors to take advantage of the digital writing pad technology. A useful option stemming from the digital writing pad concept would be the ability to handwrite any image onto an Internet supported webpage in real time. Digital writing pads allow people to capture and store everything that one handwrites on a PC or MAC. Digital writing pads also allow storage of information handwritten on the pad itself. These products clearly help to provide a culture of environmental responsibility since less natural resources are consumed. This capability would eliminate the need for private tutors to travel to their clients to do face to face discussions. This potentially means less vehicles on the road acting on behalf of educational service, which in turn supports the green initiative. Tutoring sessions will have audio and video capabilities as well as an online whiteboard that appears as a result of internal/external digital writing software. The online handwriting capability can be accessible to both the tutor and the person being tutored. Students will have the ability to rate the tutors. More importantly, private tutors around the world could be made available to give a child the best opportunity to succeed in their studies.

With this online handwriting technology, tutors will be able to work much easier with clients in a variety of topics and in multiple languages. An online classroom could be created using online seats. The instructor would be able to write class notes using a digital whiteboard located on the website. Students would choose their seats at the beginning of the semester. They would be required to upload their faces onto a particular seat. Students would be able to ask questions by clicking a button. The instructor would be able to select students by observing the queue of questions.

Handwriting images onto an internet or intranet supported website in real time could also prove beneficial to other industries as well. Physicians, for example, could now handwrite prescriptions on a webpage and have it readily available for a pharmacist to read. Internet savvy people who lack typing skills can now jot down messages on a webpage to communicate directly with a long lost friend hundreds (even thousands of miles away). Moreover, people can write messages in their native language and send to someone else online. In the audio/visual industry, there has been a huge uptake of computer-based audio-visual equipment in the education sector, with many schools and higher educational establishments installing projection equipment. The application of audiovisual systems is found in collaborative conferencing (which includes video-conferencing, audio-conferencing, web-conferencing and data-conferencing); presentation rooms, auditoria, and lecture halls; command and control centers; digital signage, and more. Concerts and corporate events are among the most obvious venues where, audiovisual equipment is used in a staged environment. This invention would thus be readily compatible with Automatic Message Exchange (AMX) and Crestron control panels. Finally, there is the possibility of handwriting instant messages using any Internet supported device.

### BRIEF DESCRIPTION OF THE DRAWING

FIG. 1A in the replacement drawings represents the logical software device comprising the internal hard drive of any electronic device that uses the WBWS software. Data 1 and Data 2 comprise the communication interface between the internal hard drive and the WBWS software.

FIG. 1B in the replacement drawings represents the logical software device comprising any word processor on the hard drive of any electronic device that uses the WBWS software. Data 3 and Data 4 comprise the communication interface between the word processor and the WBWS software.

FIG. 1C in the replacement drawings represents the logical software device comprising the external hard drive of any electronic device that uses the WBWS software. Data 5 and Data 6 comprise the communication interface between the external hard drive and the WBWS software.

FIG. 1D in the replacement drawings represents the logical software device comprising an internet/intranet supported webpage on any electronic device that uses the WBWS software. Data 7 and Data 8 comprise the communication interface between the internet/intranet supported webpage and the WBWS software.

FIG. 1E in the replacement drawings represents the logical software device comprising the WBWS. The WBWS and the internal hard drive (FIG. 1A of the replacement drawings) communicate with each other via the interface represented by Data 1 and Data 2. The WBWS and the word processor (FIG. 1B of the replacement drawings) communicate with each other via the interface represented by Data 3 and Data 4. The WBWS and the external hard drive (FIG. 1C of the replacement drawings) communicate with each other via the interface represented by Data 5 and Data 6. The WBWS and the internet/intranet supported webpage (FIG. 1C of the replacement drawings) communicate with each other via the interface represented by Data 7 and Data 8.

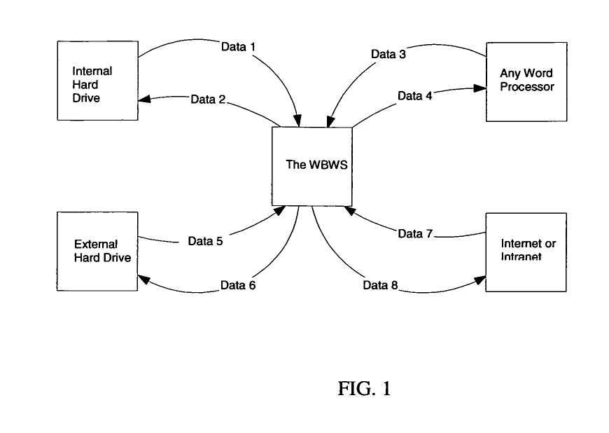

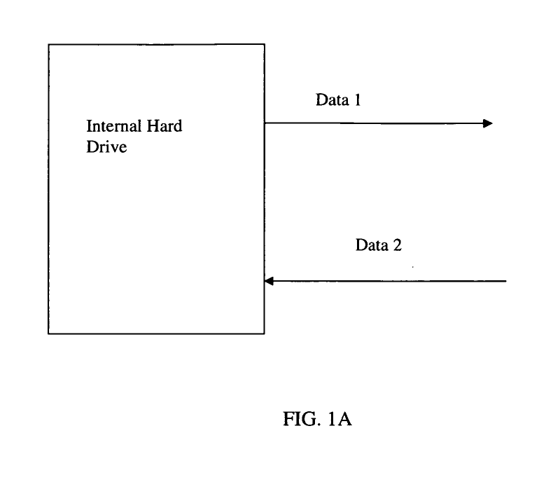

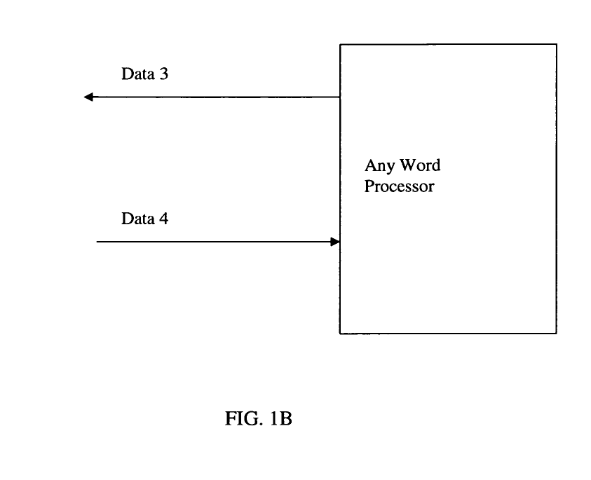

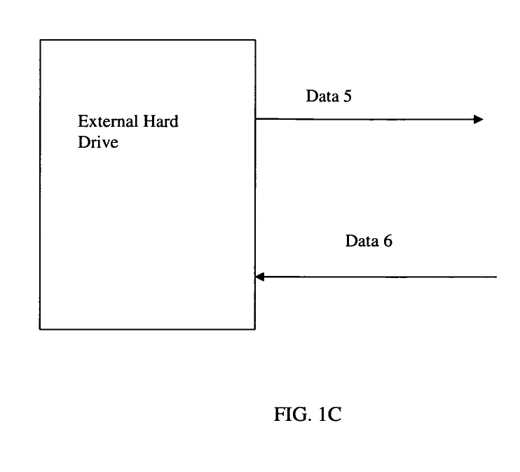

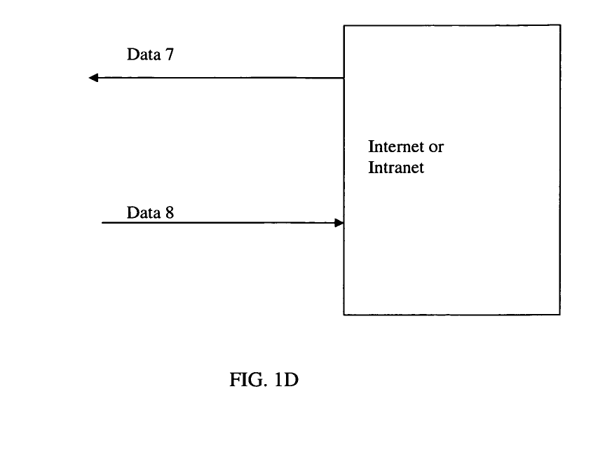

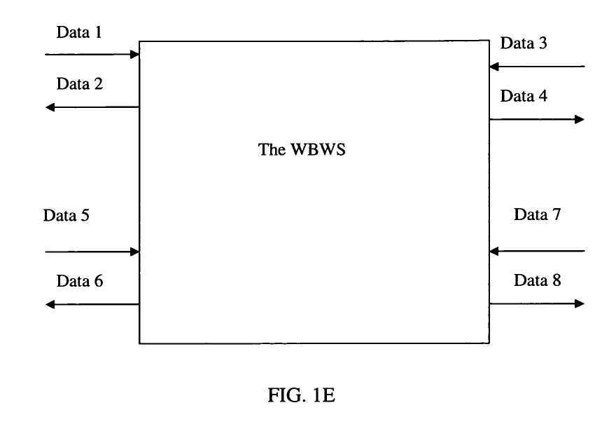

### DETAILED DESCRIPTION OF THE PREFERRED EMBODIMENTS

Data 1 and Data 2: The WBWS must support the flow of data between itself and the logical software device comprising the internal hard drive. The WBWS software must be stored on the internal hard drive, and, upon activation of the WBWS software, must be able to communicate with a WBWS supported webpage. There will be some handshaking protocol that will ensure that the WBWS software stored on the internal hard drive is not corrupted. Furthermore, WBWS software upgrades may be downloaded to the internal hard drive as well.

Data 3 and Data 4: The WBWS must support the flow of data between itself and any word processors on the hard drive containing the WBWS software.

Data 5 and Data 6: The WBWS must support the flow of data between itself and the logical software device comprising the external hard drive. Depending on the external hard drive space, the WBWS software can be stored on the external hard drive and, upon activation of the WBWS software, must be able to communicate with a WBWS supported webpage. There will be some handshaking protocol that will ensure that the WBWS software stored on the external hard drive is not corrupted. Furthermore, WBWS software upgrades may be downloaded to the external hard drive as well. The external hard drive could also be represented by a thumb drive, a printer, a scanner, a digital writing pad, cellphone, PDA, or a mouse.

Data 7 and Data 8: The WBWS must support the flow of data between itself and any internet/intranet supported webpage.

1. A logical software device representing the software that enables the website handwriting technology

2. The interface between the logical software device recited in claim 1 and a word processor on any internet/intranet supported electronic device supporting the WBWS (i.e. Windows based electronic device, Apple product, Linux supported product, PDA, cellphone, or any device with a derivative operating system)

3. The interface between the logical software device recited in claim 1 and the data network that comprises the Internet

4. The interface between the logical software device recited in claim 1 and the data network that comprises an Intranet

5. The interface between the logical software device recited in claim 1 and the logical software device representing the internal hard drive of any internet/intranet supported electronic device (i.e. Windows based electronic device, any Apple product, Linux supported product, Linux, PDA, cellphone, or any device with a derivative operating system)

6. The interface between the logical software device recited in claim 1 and the logical software device representing ANY external hard drive connected to any internet/intranet supported electronic device supporting the WBWS (i.e. Windows based electronic device, any Apple product, Linux supported product, PDA, cellphone, or any device with a derivative operating system)
